(19) United States
(12) Patent Application Publication
(10) Pub. No.: US 2026/0307727 A1
(43) Pub. Date: Oct. 8, 2026

(54) SIDE STRUCTURE OF VEHICLE BODY

(71) Applicants: Hyundai Motor Company, Seoul (KR); Kia Corporation, Seoul (KR)

(72) Inventors: Hae Hoon Lee, Hwaseong-si (KR); Sang Yeob Lee, Hwaseong-si (KR); In Yong Jeong, Hwaseong-si (KR); Dong Wook Kim, Hwaseong-si (KR); Jong Han Woo, Hwaseong-si (KR)

(21) Appl. No.: 19/565,188

(22) Filed: Mar. 12, 2026

(30) Foreign Application Priority Data
Apr. 2, 2025 (KR) 10-2025-0042549
Jul. 7, 2025 (KR) 10-2025-0090697

(51) Int. Cl. B62D 25/02; E05F 15/643

(52) U.S. Cl. CPC B62D 25/02; E05F 15/643; E05Y 2900/531

(57) ABSTRACT

A side structure of a vehicle body may include a side inner assembly including a quarter pillar inner member and a rear pillar inner member, a quarter main member connected to the quarter pillar inner member and the rear pillar inner member of the side inner assembly along a longitudinal direction of the vehicle body, a wheel house connection member disposed below the quarter main member, wherein a mount space is partitioned between the quarter main member and the wheel house connection member, a mounting bracket disposed in the mount space, and mounting bracket being connected to the quarter main member and the wheel house connection member, and a power sliding door (PSD) drive unit mounted on the mounting bracket.

### CROSS-REFERENCE TO RELATED APPLICATIONS

This application claims priority to and the benefit of Korean Patent Application No. 10-2025-0042549 filed with the Korean Intellectual Property Office on Apr. 2, 2025, and Korean Patent Application No. 10-2025-0090697 filed with the Korean Intellectual Property Office on Jul. 7, 2025, the entire contents of which are incorporated herein by reference.

### TECHNICAL FIELD

The present disclosure relates to a side structure of a vehicle body.

### BACKGROUND

Recently, the vehicle industry has been introducing a new concept of future mobility vision for realizing a dynamic, human-centered future city. One of these future mobility solutions is a purpose-based mobility (Purpose Built Vehicle (PBV)).

An example of a PBV is an electric vehicle (EV)-based environment-friendly mobile vehicle. Such a PBV can provide various customized services to users during the time moving from an origin to a destination.

A PBV can be manufactured in various shapes and sizes according to a user's use case. For example, a PBV can be utilized as a hailing or delivery type vehicle.

Meanwhile, in order to provide users with a wide and convenient entry and exit space, hailing vehicles are adopting sliding doors for the side structure of the PBV vehicle body.

A sliding door may be, for example, a power sliding door (PSD) that is automatically opened and closed by a simple switch operation.

The power sliding door can be automatically opened and closed along the longitudinal direction of vehicle body by the operation of a PSD drive unit mounted on the side structure of the vehicle body.

The PSD drive unit includes an actuator such as a motor or a cylinder, and a power delivery device such as a cable, a belt, a pulley, or a gear.

The PSD drive unit as described above has a relatively large size, and vibration may occur during operation.

Therefore, it is necessary to robustly mount the PSD drive unit in a rear quarter section while securing a space to mount the PSD drive unit in the rear quarter section of the side structure.

Accordingly, in order to avoid interference between the PSD drive unit and peripheral devices, a notched mount space is formed on one side of the rear quarter section, and the PSD drive unit is mounted in the mount space.

However, because the PSD drive unit is eccentrically mounted on one side of the rear quarter section, cable twisting may occur due to the difference in length between the front and rear cables, and vibration may occur during the operation of the PSD drive unit due to an asymmetric reaction force.

Furthermore, because the PSD drive unit is mounted in a notched mount space on one side of the rear quarter section, the mounting stiffness of the PSD drive unit, the torsional stiffness and durability of the side structure, etc., may be deteriorated.

The matters described in this background section are intended to enhance understanding of the background of the present disclosure and may include matters that are not conventional art already publicly known, available, or in use.

### SUMMARY

The disclosed example embodiments relate to a vehicle body, and more particularly, the present disclosure relates to a side structure of a vehicle body to which an automatically operating power sliding door (PSD) is applied.

Some embodiments of the present disclosure may provide a side structure of a vehicle body capable of attenuating vibration generated during operation of a PSD drive unit and strengthening torsional stiffness and durability of the side structure.

A side structure of a vehicle body according to the some embodiments of the present disclosure may include: a quarter main member connected to a quarter pillar inner member and a rear pillar inner member of a side inner assembly along a longitudinal direction of vehicle body; a wheel house connection member disposed below the quarter main member; a mounting bracket disposed in a mount space partitioned between the quarter main member and the wheel house connection member, and connected to the quarter main member and the wheel house connection member; and a PSD (Power Sliding Door) drive unit mounted on the mounting bracket.

The mount space may be partitioned and formed between a lower portion of the quarter main member, an upper portion of the wheel house connection member, the quarter pillar inner member, and the rear pillar inner member.

The PSD drive unit may include a front cable and a rear cable connected to the quarter pillar inner member and the rear pillar inner member, respectively, and may be mounted on the mounting bracket at a position where lengths of the front cable and the rear cable are the same.

The PSD drive unit may include mounting ribs extending radially from a central portion and connected to the mounting bracket.

The mounting ribs may include mounting sections formed at the same distance from a mass center point of the PSD drive unit.

A rubber bush may be mounted in the mounting sections.

The mounting bracket may include mounting holes connected to the mounting sections.

The mounting bracket may include an upper flange portion formed at an upper portion and connected to the quarter main member, and a lower flange portion formed at a lower portion and connected to the wheel house connection member.

The mounting bracket may be connected to the quarter main member and the wheel house connection member along a vertical direction, and may be connected along a width direction of vehicle body to a side outer assembly connected with the side inner assembly.

The side structure of the vehicle body may further include an adhesive pad attached to an outer surface of the mounting bracket and adhered to a side outer assembly connected with the side inner assembly.

The mounting bracket may include an upper flange portion formed at an upper portion and connected to the quarter main member, a lower flange portion formed at a lower portion and connected to the wheel house connection member, and a forming portion formed between the upper flange portion and the lower flange portion.

A first mounting hole may be formed at an upper center of the forming portion, and a second mounting hole and a third mounting hole may be formed at both lower sides of the forming portion.

The PSD drive unit may include mounting ribs formed in a radial manner, the mounting ribs may include mounting sections formed at the same distance from a mass center point of the PSD drive unit, and the mounting sections may be connected to the first mounting hole, the second mounting hole, and the third mounting hole.

An adhesive pad may be attached to an outer surface of the forming portion, and a side outer assembly connected with the side inner assembly may be adhered to the adhesive pad.

The mounting bracket may further include a side rib portion extending from both lower sides of the forming portion along the longitudinal direction of vehicle body, respectively, and connected to a peripheral device mounted on at least one of the quarter pillar inner member and the rear pillar inner member.

In a side structure of a vehicle body according to some embodiments, the mounting stiffness of the PSD drive unit can be strengthened, and vibration generated during operation of the PSD drive unit can be effectively attenuated.

Other advantages obtained or predicted by some embodiments will be disclosed directly or implicitly in the detailed description of the disclosed example embodiments. That is, various advantages predicted according to the disclosed example embodiments will be disclosed in the detailed description to be described later.

### BRIEF DESCRIPTION OF THE DRAWINGS

Because these drawings are for reference in explaining the disclosed example embodiments, technical ideas of the disclosed example embodiments should not be interpreted as being necessarily limited to the accompanying drawings.

FIG. 1 is an external perspective view showing a vehicle body to which a side structure of a vehicle body according to a disclosed example embodiment of the present disclosure can be applied.

FIG. 2 is an exploded perspective view showing a side structure of a vehicle body according to a disclosed example embodiment of the present disclosure.

FIGS. 3 and 4 are perspective views showing a side structure of a vehicle body according to a disclosed example embodiment of the present disclosure.

FIGS. 5 and 6 are exploded perspective views showing a side structure of a vehicle body according to a disclosed example embodiment of the present disclosure.

FIGS. 7 and 8 are side views showing a side structure of a vehicle body according to a disclosed example embodiment of the present disclosure.

FIGS. 9A and 9B are drawings showing a mounting bracket configured to be applied to a side structure of a vehicle body according to a disclosed example embodiment of the present disclosure.

FIG. 10 is a drawing showing a connecting structure of a mounting bracket and peripheral devices applied to a side structure of a vehicle body according to a disclosed example embodiment of the present disclosure.

FIGS. 11A and 11B are drawings showing a PSD drive unit configured to be applied to a side structure of a vehicle body according to a disclosed example embodiment of the present disclosure.

FIGS. 12A and 12B are drawings showing a connecting structure of a mounting bracket and a PSD drive unit configured to be applied to a side structure of a vehicle body according to a disclosed example embodiment of the present disclosure.

FIG. 13 is an exploded perspective view showing a connecting structure of a mounting bracket and a side outer assembly applied to a side structure of a vehicle body according to a disclosed example embodiment of the present disclosure.

FIG. 14 is a cross-sectional view showing a side structure of a vehicle body according to a disclosed example embodiment of the present disclosure.

The drawings referred to above are not necessarily shown to scale and may be presenting a somewhat simplified representation of various features illustrating some principles of the disclosed example embodiments. For example, specific design features of the disclosed example embodiments, including specific dimensions, directions, positions, and shapes, may be determined for other embodiments in part by the specific intended application and use environment.

### DETAILED DESCRIPTION OF ILLUSTRATIVE EMBODIMENTS

Next, the disclosed example embodiments will be described in detail with reference to the accompanying drawings so that a person of ordinary skill in the art to which the disclosed example embodiments pertain can easily implement them. However, the disclosed example embodiments may be implemented in many different forms for other embodiments of the present disclosure, and the present disclosure is not necessarily limited to the example embodiments described herein.

Terminology used herein is for the purpose of describing specific example embodiments and is not intended to necessarily limit the present disclosure. As used herein, singular forms may be intended to include plural forms as well, unless the context clearly indicates otherwise.

The terms “comprises” and/or “comprising” used in this specification indicate the presence of stated features, integers, steps, operations, elements, and/or components, but do not exclude the presence or addition of one or more other features, integers, steps, operations, components, and/or groups thereof. As used herein, the term “and/or” may include any one or all combinations of one or more of the associated listed items.

In this specification, the term “connected” may indicate a physical relationship between two components in which components are directly connected to each other or indirectly connected through one or more intermediate components by welding, SPR (Self Piercing Rivet), FDS (Flow Drill Screw), structural adhesive, or the like, for example.

As used herein, “vehicle,” “of a vehicle,” “vehicular,” or other similar terms, used in this specification may generally include passenger automobiles including passenger vehicles, sports cars, sports utility vehicles (SUV), buses, trucks, and various commercial vehicles, and may include hybrid vehicles, electric vehicles, hybrid electric vehicles, electric vehicle-based PBVs (Purpose Built Vehicles), hydrogen power vehicles, and other alternative fuel vehicles (e.g., fuels derived from resources other than petroleum), for example.

Next, some example embodiments will be described in detail with reference to the accompanying drawings.

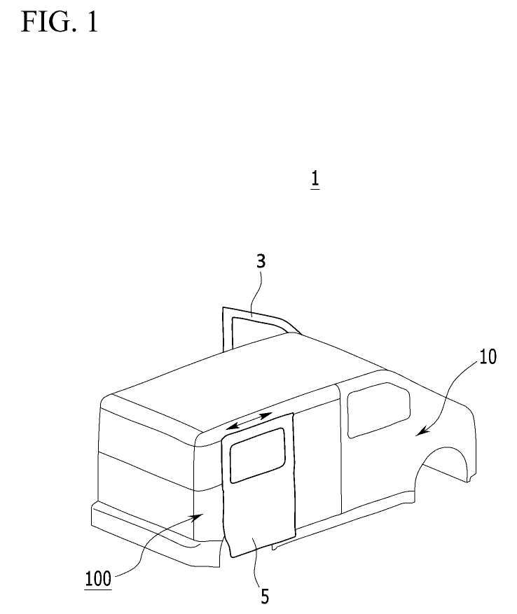

FIG. 1 is an external perspective view showing a vehicle body to which a side structure of a vehicle body according to a disclosed example embodiment can be applied.

Referring to FIG. 1, a side structure of a vehicle body 100 according to a disclosed example embodiment may be applied to, for example, a vehicle body 1 of a purpose built vehicle (hereinafter referred to as “PBV”).

In some embodiments, the PBV may be utilized as, for example, an electric vehicle-based life module vehicle that provides various customized services to users during the time of moving from an origin to a destination.

In one example, the PBV may be manufactured in a one-box type design with a wide vehicle interior space. In another example, the PBV may apply a plurality of rows of seats and face-to-face type seats in the vehicle interior space.

In some embodiments, the vehicle body 1 of such a PBV may be manufactured in various shapes and sizes according to the purpose of use and use case of the PBV.

In some embodiments, the vehicle body 1 of the PBV may be utilized for various vehicle types, for example, a hailing vehicle as an occupant transport means, a delivery vehicle for goods transport, and a special vehicle such as an ambulance.

In some embodiments, reference directions for describing the following components may be set as the longitudinal direction of vehicle body (e.g., vehicle body length direction or longitudinal direction), the width direction of vehicle body (e.g., transverse direction or left-right direction), and the vertical direction (e.g., height direction), with the vehicle body as a reference.

In some embodiments, an “upper end portion”, “upper portion”, “top”, or “upper surface” of a component may indicate an end, part, top, or surface of a component relatively on the upper side in the drawing, and a “lower end portion”, “lower portion”, “bottom”, or “lower surface” of a component may indicate an end, part, bottom, or surface of a component relatively on the lower side in the drawing.

In some embodiments, an end of a component (e.g., one end, the other end, or both ends, etc.) may indicate the end of the component in any one direction, and an end portion of a component (e.g., one end portion, the other end portion, both end portions, a front end portion, or a rear end portion, etc.) may indicate a certain part of the component including the end.

In some embodiments, the vehicle body 1 of the PBV as described above may include, for example, a front door 3 mounted on one side along the width direction of vehicle body, and a sliding door 5 mounted on the other side.

In some embodiments, the side structure of the vehicle body 100 that can be applied to such a vehicle body 1 of the PBV may include side structure bodies 10 respectively disposed on both sides along the width direction of vehicle body.

In some embodiments, the side structure body 10 may include the sliding door 5 mentioned above. The sliding door 5 can open and close a sliding door opening portion formed in the side structure body 10. The sliding door 5 can be moved along the longitudinal direction of vehicle body along guide rails provided at the upper and lower portions of the side structure body 10. Such a sliding door 5 may be a power sliding door (PSD) that is automatically opened and closed by the operation of an actuator.

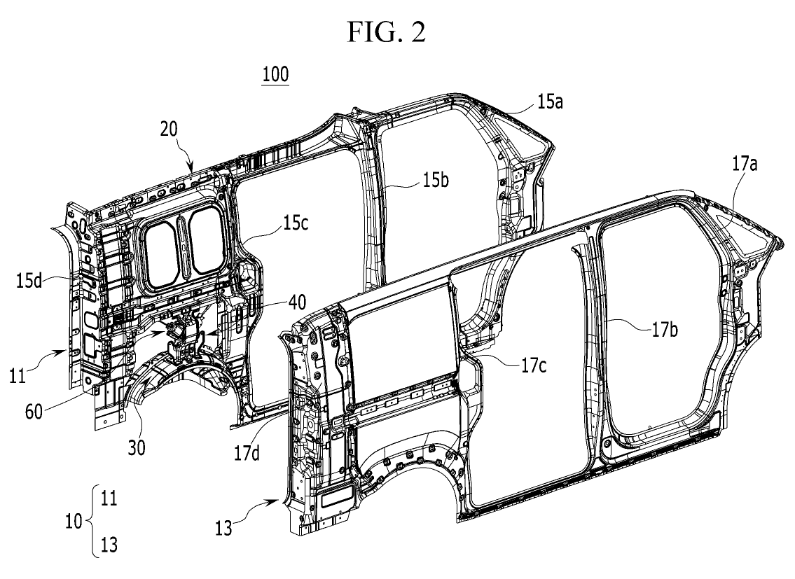

FIG. 2 is an exploded perspective view showing a side structure of a vehicle body according to a disclosed example embodiment.

Referring to FIGS. 1 and 2, in the disclosed example embodiment, the side structure body 10 may include a side inner assembly 11 and a side outer assembly 13 coupled with the side inner assembly 11.

In some embodiments, the side inner assembly 11 may include a front pillar inner member 15a, a center pillar inner member 15b, a quarter pillar inner member 15c, and a rear pillar inner member 15d.

In some embodiments, the side outer assembly 13 may include a front pillar outer member 17a, a center pillar outer member 17b, a quarter pillar outer member 17c, and a rear pillar outer member 17d.

In some embodiments, the front pillar, center pillar, quarter pillar, and rear pillar are defined for convenience of understanding and may be the A pillar, B pillar, C pillar, and D pillar used in the industry.

In some embodiments, the side inner assembly 11 and the side outer assembly 13 may be coupled along the width direction of vehicle body.

Accordingly, in some embodiments, a sliding door opening portion may be formed between the center pillar assembly of the center pillar inner member 15b and the center pillar outer member 17b coupled to each other, and the quarter pillar assembly of the quarter pillar inner member 15c and the quarter pillar outer member 17c coupled to each other.

In some embodiments, the side structure of the vehicle body 100 may provide a structure capable of attenuating vibration generated during the opening/closing operation of the sliding door 5 and strengthening the torsional stiffness and durability of the side structure body 10.

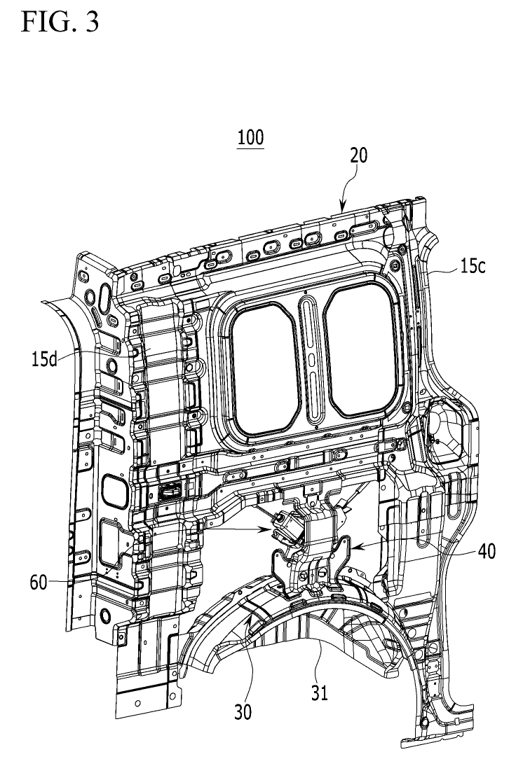

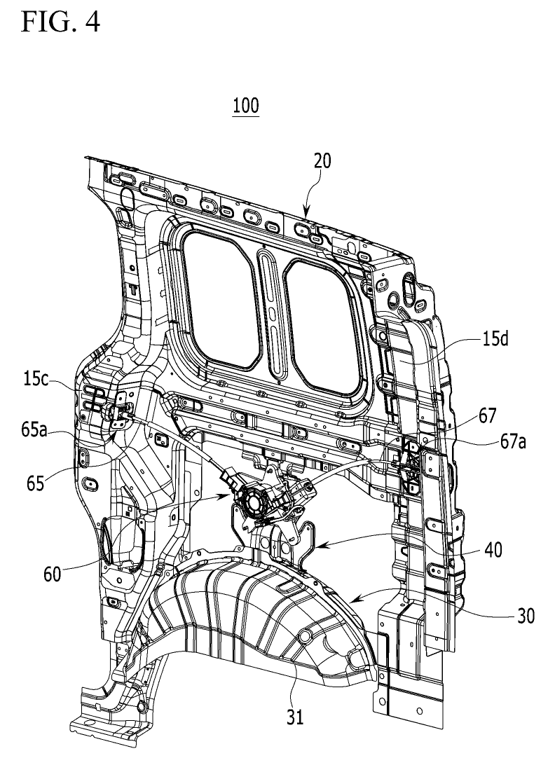

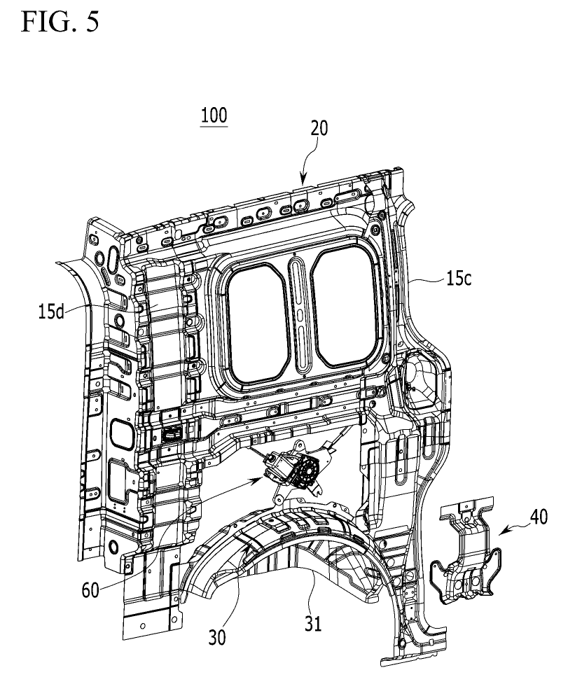

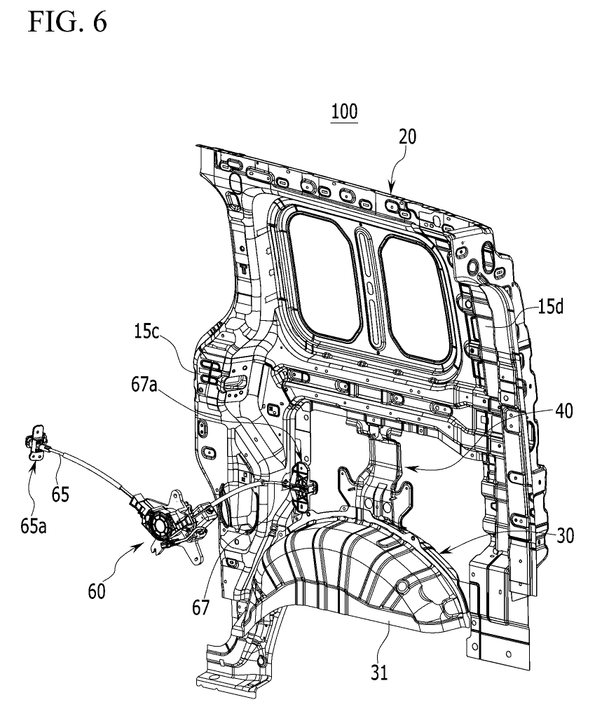

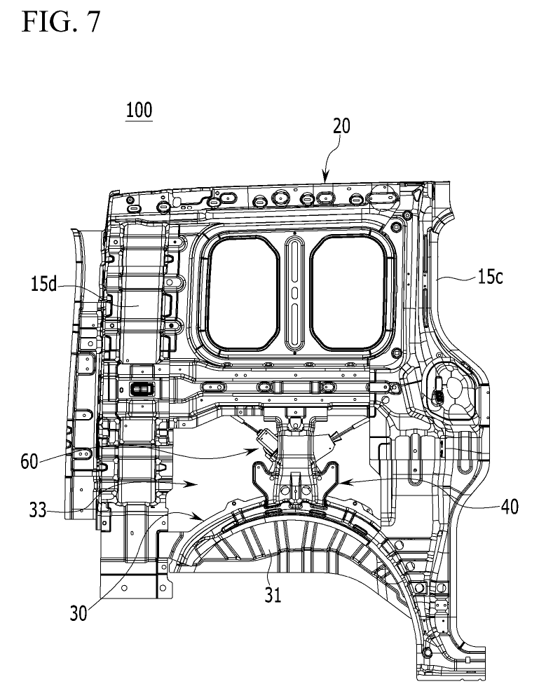

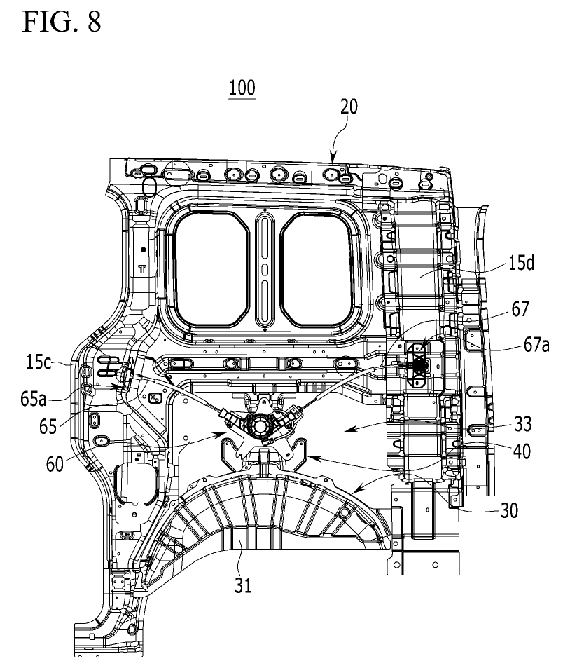

FIGS. 3 and 4 are perspective views showing a side structure of a vehicle body according to a disclosed example embodiment. FIGS. 5 and 6 are exploded perspective views showing a side structure of a vehicle body according to a disclosed example embodiment. FIGS. 7 and 8 are side views showing a side structure of a vehicle body according to a disclosed example embodiment.

Referring to FIGS. 3 to 8, in some embodiments, the side structure of the vehicle body 100 may include a quarter main member 20, a wheel house connection member 30, a mounting bracket 40, and a PSD drive unit 60.

In some embodiments, the quarter main member 20, the wheel house connection member 30, the mounting bracket 40, and the PSD drive unit 60 may be provided in the side inner assembly 11 (see, e.g., FIG. 2).

In some embodiments, the quarter main member 20 may be disposed between the quarter pillar inner member 15c and the rear pillar inner member 15d.

In some embodiments, the quarter main member 20 may be connected to the quarter pillar inner member 15c and the rear pillar inner member 15d along the longitudinal direction of vehicle body.

In some embodiments, the wheel house connection member 30 may be disposed below the quarter main member 20 between the quarter pillar inner member 15c and the rear pillar inner member 15d.

In some embodiments, the wheel house connection member 30 may be connected to the quarter pillar inner member 15c and the rear pillar inner member 15d along the longitudinal direction of vehicle body.

In some embodiments, the wheel house connection member 30 may be coupled with a wheel house member 31 connected to the quarter pillar inner member 15c and the rear pillar inner member 15d along the longitudinal direction of vehicle body.

In some embodiments, the side inner assembly 11 may include a mount space 33 partitioned and formed between the lower portion of the quarter main member 20, the upper portion of the wheel house connection member 30, the quarter pillar inner member 15c, and the rear pillar inner member 15d.

In some embodiments, the mounting bracket 40 may be configured to mount the PSD drive unit 60, which will be described later, in the mount space 33. In some embodiments, the mounting bracket 40 may be configured to reinforce the vehicle body strength around the mount space 33.

In some embodiments, the mounting bracket 40 may be disposed at approximately the middle point of the mount space 33 and may be coupled to the lower portion of the quarter main member 20 and the upper portion of the wheel house connection member 30. The mounting bracket 40 may be connected to the quarter main member 20 and the wheel house connection member 30 along the vertical direction.

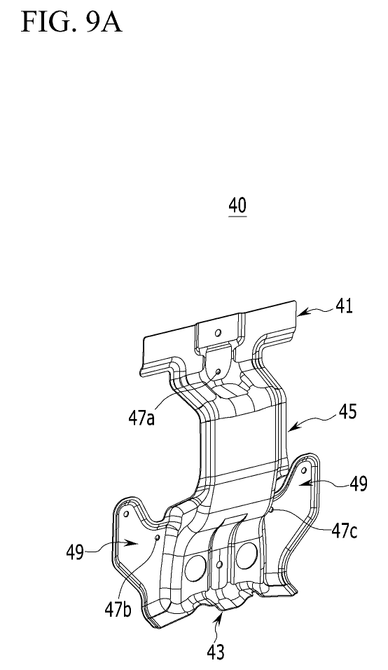

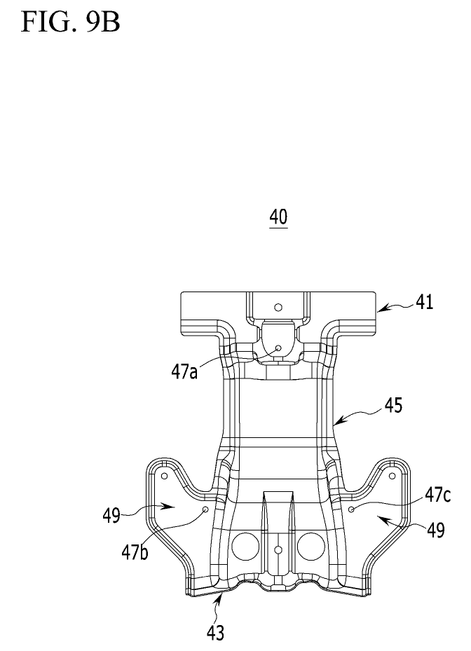

FIGS. 9A and 9B are drawings showing a mounting bracket configured to be applied to a side structure of a vehicle body according to a disclosed example embodiment.

As illustrated in FIGS. 9A and 9B, in some embodiments, the mounting bracket 40 may include an upper flange portion 41, a lower flange portion 43, and a forming portion 45.

In some embodiments, the upper flange portion 41 may be formed at the upper portion of the mounting bracket 40 and may be coupled to the lower portion of the quarter main member 20. The upper flange portion 41 may be coupled to the lower portion of the quarter main member 20 by welding, for example.

In some embodiments, the lower flange portion 43 may be formed at the lower portion of the mounting bracket 40 and may be coupled to the upper portion of the wheel house connection member 30. The lower flange portion 43 may be coupled to the upper portion of the wheel house connection member 30 by welding, for example.

In some embodiments, the forming portion 45 may be formed between the upper flange portion 41 and the lower flange portion 43. The forming portion 45 may be provided in a shape convexly formed in an outward side direction from the upper flange portion 41 and the lower flange portion 43.

In some embodiments, the mounting bracket 40 may include a plurality of mounting holes 47a, 47b, and 47c for mounting the PSD drive unit 60 to be described later. Three mounting holes 47a, 47b, and 47c may be formed as illustrated in FIGS. 9A and 9B, but are not limited thereto.

In some embodiments, the mounting holes 47a, 47b, and 47c may be disposed in a radial manner from the center of the mounting bracket 40 and may be disposed in a symmetrical shape along the longitudinal direction of vehicle body.

In some embodiments, the mounting holes 47a, 47b, and 47c may include a first mounting hole 47a, a second mounting hole 47b, and a third mounting hole 47c.

In some embodiments, the first mounting hole 47a may be formed at the upper center of the forming portion 45. And, the second mounting hole 47b and the third mounting hole 47c may be respectively formed at both lower sides (e.g., both sides along the longitudinal direction of vehicle body) of the forming portion 45.

In some embodiments, the mounting bracket 40 may further include a side rib portion 49 respectively extending from both lower sides of the forming portion 45 along the longitudinal direction of vehicle body.

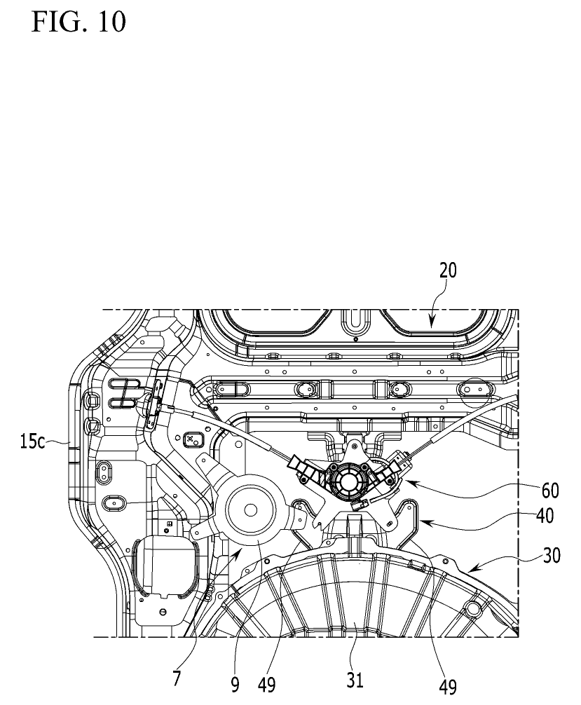

FIG. 10 is a drawing showing a connecting structure of a mounting bracket and peripheral devices applied to a side structure of a vehicle body according to a disclosed example embodiment.

As illustrated in FIG. 10, in some embodiments, the side rib portion 49 may be coupled to a peripheral device 7 mounted on at least one of the quarter pillar inner member 15c and the rear pillar inner member 15d.

For example, in some embodiments, the side rib portion 49 may be coupled to the peripheral device 7 mounted on the quarter pillar inner member 15c. The peripheral device 7 may include a speaker 9 in one example.

Referring to FIGS. 3 to 8, in some embodiments, the PSD (Power Sliding Door) drive unit 60 may be configured to automatically open and close the sliding door 5 (see, e.g., FIG. 1) along the longitudinal direction of vehicle body.

In some embodiments, the PSD drive unit 60 may be installed in the side inner assembly 11 as illustrated in FIG. 2 and may be operatively connected to the sliding door 5.

In some embodiments, the PSD drive unit 60 may be mounted on the inner surface of the mounting bracket 40.

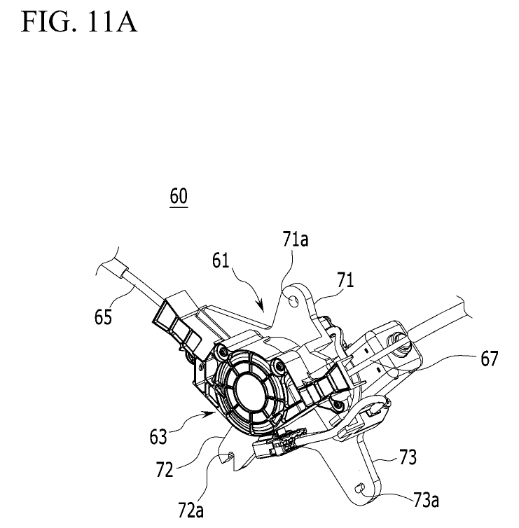

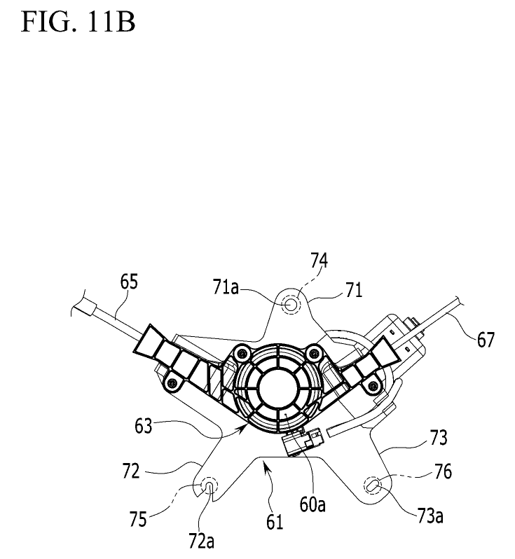

FIGS. 11A and 11B are drawings showing a PSD drive unit configured to be applied to a side structure of a vehicle body according to a disclosed example embodiment.

As illustrated in FIGS. 11A and 11B, in some embodiments, the PSD drive unit 60 may include a base block 61 and a drive main body 63 installed on the base block 61.

In some embodiments, the base block 61 may be coupled to the inner surface of the mounting bracket 40. The drive main body 63 may be an operational element that automatically opens and closes the sliding door 5 and may include an actuator such as a motor or an operation cylinder, and a power delivery mechanism connected to the actuator.

In some embodiments, the drive main body 63 may include a front cable 65 and a rear cable 67 disposed along the longitudinal direction of vehicle body.

In some embodiments, the front cable 65 and the rear cable 67 may be connected to the quarter pillar inner member 15c and the rear pillar inner member 15d, respectively, through a front cable socket 65a and a rear cable socket 67a as illustrated in FIGS. 4, 6 and 8.

For some embodiments, the configuration and operation of the drive main body 63 may be apparent to those skilled in the art, and thus a detailed description thereof will be omitted.

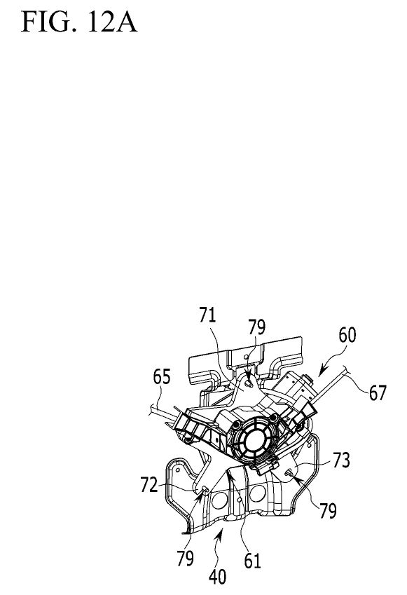

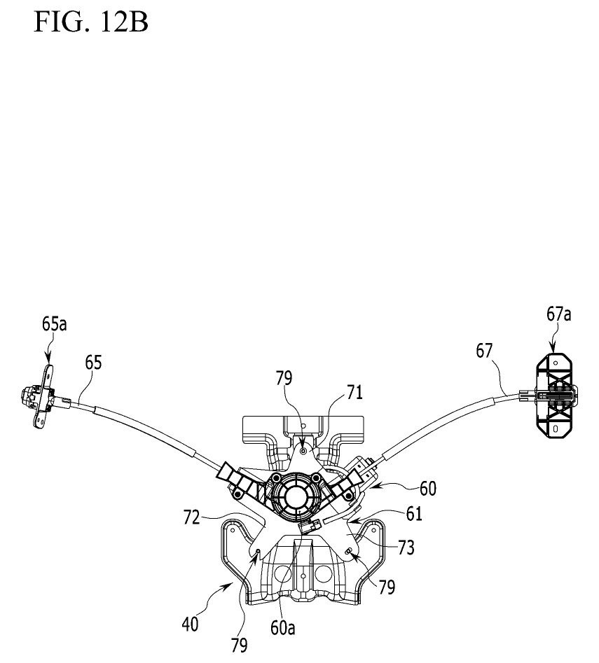

FIGS. 12A and 12B are drawings showing a connecting structure of a mounting bracket and a PSD drive unit configured to be applied to a side structure of a vehicle body according to a disclosed example embodiment.

Referring to FIGS. 11A to 12B, in some embodiments, the base block 61 may include mounting ribs 71, 72, and 73 extending radially from a central portion.

In some embodiments, the mounting ribs 71, 72, and 73 may be coupled to the inner surface of the mounting bracket 40. For example, three mounting ribs 71, 72, and 73 may be provided. The mounting ribs 71, 72, and 73 may be disposed in a symmetrical shape along the longitudinal direction of vehicle body, for example.

In some embodiments, the mounting ribs 71, 72, and 73 may include a first mounting rib 71, a second mounting rib 72, and a third mounting rib 73.

In some embodiments, these mounting ribs 71, 72, and 73 may include a plurality of mounting sections 71a, 72a, and 73a formed at the same distance from the mass center point 60a of the PSD drive unit 60. For example, three mounting sections 71a, 72a, and 73a may be formed as shown in FIG. 11B, but are not limited thereto.

In some embodiments, because the plurality of mounting sections 71a, 72a, and 73a may be formed at the same distance from the mass center point 60a of the PSD drive unit 60, an asymmetric reaction force applied to the PSD drive unit 60 can be minimized. In some embodiments, the mounting stiffness of the PSD drive unit 60 can be strengthened, and vibration generated during operation of the PSD drive unit 60 can be effectively attenuated.

In some embodiments, the mounting sections 71a, 72a, and 73a may include a first mounting section 71a, a second mounting section 72a, and a third mounting section 73a.

In some embodiments, each of the first mounting section 71a, the second mounting section 72a, and the third mounting section 73a (illustrated in FIG. 11B) may be connected to the first mounting hole 47a, the second mounting hole 47b, and the third mounting hole 47c of the mounting bracket 40 (illustrated in FIGS. 9A and 9B).

In some embodiments, as illustrated in FIG. 11B, rubber bushes 74, 75, and 76 may be mounted in each of the first mounting section 71a, the second mounting section 72a, and the third mounting section 73a.

In some embodiments, the connection structure of the PSD drive unit 60 and the mounting bracket 40 may be such that the PSD drive unit 60 may be connected with the mounting bracket 40 in a state where the mounting bracket 40 is connected along the vertical direction with the quarter main member 20 and the wheel house connecting member 30 in the mount space 33, as illustrated in FIGS. 7 and 8.

In some embodiments, the PSD drive unit 60 may be mounted on the mounting bracket 40 at a position where the lengths of the front cable 65 and the rear cable 67 are the same. In some embodiments, the position where the lengths of the front cable 65 and the rear cable 67 are the same does not necessarily mean that the lengths of the front cable 65 and the rear cable 67 are exactly the same, but rather that they are disposed with similar lengths so as to prevent cable twisting of the PSD drive unit 60 due to vehicle vibration.

Specifically, in some embodiments, the base block 61 of the PSD drive unit 60 may be disposed on the inner surface of the mounting bracket 40.

In some embodiments, the first mounting rib 71, the second mounting rib 72, and the third mounting rib 73 of the base block 61 may be disposed at positions corresponding to the first mounting hole 47a, the second mounting hole 47b, and the third mounting hole 47c of the mounting bracket 40.

In some embodiments, the first mounting section 71a, the second mounting section 72a, and the third mounting section 73a of the mounting ribs 71, 72, and 73 may be connected to the first mounting hole 47a, the second mounting hole 47b, and the third mounting hole 47c.

In some embodiments, when a fastening member 79 including a bolt and a nut is engaged with the mounting sections 71a, 72a, and 73a and the mounting holes 47a, 47b, and 47c connected to each other, the PSD drive unit 60 and the mounting bracket 40 may be coupled.

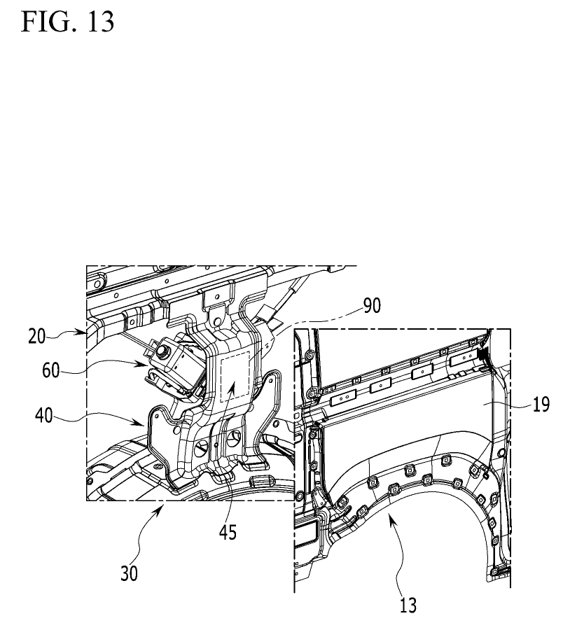

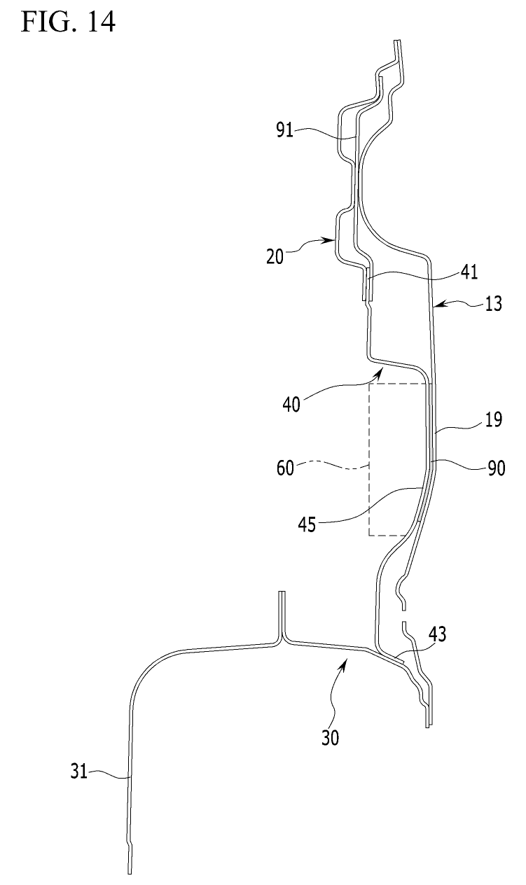

FIG. 13 is an exploded perspective view showing a connecting structure of a mounting bracket and a side outer assembly applied to a side structure of a vehicle body according to a disclosed example embodiment. FIG. 14 is a cross-sectional view showing a side structure of a vehicle body according to a disclosed example embodiment.

As illustrated in FIGS. 13 and 14, in some embodiments, the mounting bracket 40 connected to the quarter main member 20 and the wheel house connection member 30 along the vertical direction may be connected to the side outer assembly 13 along the width direction of vehicle body.

In some embodiments, the side structure of the vehicle body 100 may further include an adhesive pad 90 attached to the outer surface of the mounting bracket 40.

In some embodiments, the adhesive pad 90 may be attached to the forming portion 45 of the mounting bracket 40. Such an adhesive pad 90 may be adhered to the side outer assembly 13 along the width direction of vehicle body.

In some embodiments, the adhesive pad 90 may be adhered to the side panel 19 provided in the side outer assembly 13 along the width direction of vehicle body.

In FIG. 14, drawing reference numeral 91 indicates a quarter reinforcement member. In some embodiments, the quarter reinforcement member 91 may be configured to reinforce the lower portion of the quarter main member 20. The quarter reinforcement member 91 may be coupled to the lower portion of the quarter main member 20 with the upper flange portion 41 of the mounting bracket 40 coupled to the lower portion of the quarter main member 20 interposed therebetween.

Next, an assembly process and operation of a side structure of the vehicle body 100 according to some example embodiments configured as described above will be described in detail with reference to FIGS. 1 to 14.

In some embodiments, the side inner assembly 11 and the side outer assembly 13 of the side structure body 10 may be provided.

In some embodiments, the side inner assembly 11 may be in a state of being coupled to an underbody of the vehicle body 1, and the side outer assembly 13 may be in a state of being separated from the side inner assembly 11.

In some embodiments, the side inner assembly 11 may include the quarter main member 20 and the wheel house connection member 30 disposed between the quarter pillar inner member 15c and the rear pillar inner member 15d.

In some embodiments, the mount space 33 may be partitioned and formed between the lower portion of the quarter main member 20, the upper portion of the wheel house connection member 30, the quarter pillar inner member 15c, and the rear pillar inner member 15d.

In some embodiments, the mounting bracket 40 and the PSD drive unit 60 may be provided.

In such a state, a process of assembling the mounting bracket 40 to the side inner assembly 11 may be performed.

In some embodiments, the mounting bracket 40 may include the first mounting hole 47a formed at the upper center of the forming portion 45, and the second mounting hole 47b and the third mounting hole 47c respectively formed at both lower sides of the forming portion 45.

In the above process, the mounting bracket 40 may be disposed at approximately the middle point of the mount space 33. In such a state, the mounting bracket 40 may be coupled to the lower portion of the quarter main member 20 by the upper flange portion 41, and may be coupled to the upper portion of the wheel house connection member 30 by the lower flange portion 43.

And, in the above process, the side rib portion 49 of the mounting bracket 40 may be coupled to the peripheral device 7 mounted on the quarter pillar inner member 15c. The side rib portion 49 may be coupled to the speaker 9 by, for example, a fastening member including a bolt and a nut.

In some embodiments, a process of mounting the PSD drive unit 60 on the mounting bracket 40 may be performed.

In some embodiments, the first mounting rib 71, the second mounting rib 72, and the third mounting rib 73 may be formed on the base block 61 of the PSD drive unit 60. And, the first mounting section 71a, the second mounting section 72a, and the third mounting section 73a may be formed on each of the first mounting rib 71, the second mounting rib 72, and the third mounting rib 73.

In the above process, on the inner surface of the mounting bracket 40, the PSD drive unit 60 may be disposed at a position where the first mounting section 71a, the second mounting section 72a, and the third mounting section 73a are mutually connected to the first mounting hole 47a, the second mounting hole 47b, and the third mounting hole 47c.

In some embodiments, the fastening member 79 may be engaged with the mounting sections 71a, 72a, and 73a and the mounting holes 47a, 47b, and 47c connected to each other. Accordingly, in some embodiments, the PSD drive unit 60 can be fixed to the mounting bracket 40 by the fastening member 79.

In some embodiments, the fastening member 79 can engage the mounting bracket 40 and the PSD drive unit 60 through the rubber bushes 74, 75, and 76 mounted in each of the first mounting section 71a, the second mounting section 72a, and the third mounting section 73a.

In some embodiments, the front cable 65 and the rear cable 67 of the PSD drive unit 60 may be connected to the quarter pillar inner member 15c and the rear pillar inner member 15d through the front cable socket 65a and the rear cable socket 67a.

In some embodiments, the PSD drive unit 60 can be fixed to the inner surface of the mounting bracket 40 at a position where the lengths of the front cable 65 and the rear cable 67 are the same.

In some embodiments, the adhesive pad 90 may be attached to the forming portion 45 of the mounting bracket 40. The adhesive pad 90 may be attached to the outer surface of the forming portion 45.

In the state as described above, in some embodiments, the side outer assembly 13 may be coupled to the side inner assembly 11.

In some embodiments, the adhesive pad 90 may be adhered to the inner surface of the side panel 19 provided in the side outer assembly 13. Accordingly, the mounting bracket 40 and the side panel 19 can be coupled along the width direction of vehicle body by the adhesive pad 90.

According to the side structure of the vehicle body 100 assembled through a series of assembly processes as described above, in some embodiments, the mount space 33 partitioned by the quarter main member 20, the wheel house connection member 30, the quarter pillar inner member 15c, and the rear pillar inner member 15d can be secured.

According to the side structure of the vehicle body 100 for some embodiments, in the mount space 33, the mounting bracket 40 may be coupled to the quarter main member 20 and the wheel house connection member 30 along the vertical direction, and the PSD drive unit 60 can be mounted on the mounting bracket 40.

In some embodiments, for the side structure of the vehicle body 100, the PSD drive unit 60 mounted on the mounting bracket 40 may be connected to the quarter pillar inner member 15c and the rear pillar inner member 15d through the front cable 65 and the rear cable 67, and can be disposed at a position where the lengths of the front cable 65 and the rear cable 67 are the same.

Therefore, according to the side structure of the vehicle body 100 for some embodiments, cable twisting of the PSD drive unit 60 can be prevented.

And, according to the side structure of the vehicle body 100 for some embodiments, by minimizing the asymmetric reaction force applied to the PSD drive unit 60, the mounting stiffness of the PSD drive unit 60 can be strengthened, and vibration generated during operation of the PSD drive unit 60 can be effectively attenuated.

Furthermore, according to the side structure of the vehicle body 100 for some embodiments, as the mounting bracket 40 is connected to the quarter main member 20 and the wheel house connection member 30 in the vertical direction, the torsional stiffness and durability of the side structure body 10 can be strengthened.

According to the side structure of the vehicle body 100 for some embodiments, the rubber bushes 74, 75, and 76 may be mounted at the engagement portion of the mounting bracket 40 and the PSD drive unit 60, and the mounting bracket 40 can be coupled with the peripheral device 9.

Therefore, according to the side structure of the vehicle body 100 for some embodiments, the skeletal strength of the side structure body 10 can be reinforced, and vibration generated during operation of the PSD drive unit 60 can be more effectively attenuated.

According to the side structure of the vehicle body 100 for some embodiments, as the mounting bracket 40 is connected to the side panel 19 of the side outer assembly 13 in the width direction of vehicle body by the adhesive pad 90, the outer panel strength of the side structure body 10 can be strengthened.

While the some example embodiments disclosed above have been described, the present disclosure is not necessarily limited thereto, and various modifications can be made for other embodiments within the scopes of the claims and equivalents thereof.

What is claimed is:

1. A side structure of a vehicle body comprising:
a side inner assembly including a quarter pillar inner member and a rear pillar inner member;
a quarter main member connected to the quarter pillar inner member and the rear pillar inner member of the side inner assembly along a longitudinal direction of the vehicle body;
a wheel house connection member disposed below the quarter main member, wherein a mount space is partitioned between the quarter main member and the wheel house connection member;
a mounting bracket disposed in the mount space, wherein the mounting bracket is connected to the quarter main member and the wheel house connection member; and
a power sliding door (PSD) drive unit mounted on the mounting bracket.

2. The side structure of claim 1, wherein the mount space is defined between a lower portion of the quarter main member, an upper portion of the wheel house connection member, the quarter pillar inner member, and the rear pillar inner member.

3. The side structure of claim 1, wherein the PSD drive unit includes a front cable and a rear cable connected to the quarter pillar inner member and the rear pillar inner member, respectively, and
wherein the PSD drive unit is mounted on the mounting bracket at a position such that lengths of the front cable and the rear cable are the same.

4. The side structure of claim 1, wherein the PSD drive unit comprises:
a central portion; and
mounting ribs extending radially from the central portion, wherein the mounting ribs are connected to the mounting bracket.

5. The side structure of claim 4, wherein the mounting ribs include mounting sections disposed at the same distance from a mass center point of the PSD drive unit.

6. The side structure of claim 5, further comprising a rubber bush mounted in each of the mounting sections.

7. The side structure of claim 5, wherein the mounting bracket includes mounting holes aligned with the mounting sections of the PSD unit.

8. The side structure of claim 1, wherein the mounting bracket comprises:
an upper flange portion extending at an upper portion of the mounting bracket and connected to the quarter main member; and
a lower flange portion extending at a lower portion of the mounting bracket and connected to the wheel house connection member.

9. The side structure of claim 1, further comprising a side outer assembly connected with the side inner assembly,
wherein the mounting bracket is connected to the quarter main member and the wheel house connection member along a vertical direction, and
wherein the mounting bracket is connected along a width direction of the vehicle body to the side outer assembly.

10. The side structure of claim 1, further comprising:
a side outer assembly connected with the side inner assembly; and
an adhesive pad attached to an outer surface of the mounting bracket and adhered to the side outer assembly.

11. The side structure of claim 1, wherein the mounting bracket comprises:
an upper flange portion extending at an upper portion of the mounting bracket and connected to the quarter main member;
a lower flange portion extending at a lower portion of the mounting bracket and connected to the wheel house connection member; and
a forming portion extending between the upper flange portion and the lower flange portion.

12. The side structure of claim 11, wherein the mounting bracket comprises:
a first mounting hole at an upper center of the forming portion; and
a second mounting hole and a third mounting hole at two lower sides of the forming portion.

13. The side structure of claim 12, wherein:
the PSD drive unit includes mounting ribs extending in a radial manner;
the mounting ribs include mounting sections disposed at the same distance from a mass center point of the PSD drive unit; and
the mounting sections are connected to the first mounting hole, the second mounting hole, and the third mounting hole.

14. The side structure of claim 11, further comprising:
a side outer assembly connected with the side inner assembly; and
an adhesive pad is attached to an outer surface of the forming portion,
wherein the side outer assembly is adhered to the adhesive pad.

15. The side structure of claim 11, wherein the mounting bracket further includes side rib portions extending from two lower sides of the forming portion along the longitudinal direction of the vehicle body, respectively, and wherein the side rib portions are configured to be connected to a peripheral device mounted on the quarter pillar inner member or the rear pillar inner member.

16. A vehicle comprising:
a sliding side door;
a power sliding door (PSD) drive unit coupled to the sliding side door and configured to move the sliding side door; and
a side structure comprising:
a side inner assembly including a quarter pillar inner member and a rear pillar inner member,
a quarter main member connected to the quarter pillar inner member and the rear pillar inner member of the side inner assembly along a longitudinal direction of the vehicle,
a wheel house connection member disposed below the quarter main member, wherein a mount space is defined between the quarter main member and the wheel house connection member, and
a mounting bracket disposed in the mount space, wherein the mounting bracket is connected to the quarter main member and the wheel house connection member, and wherein the PSD drive unit is mounted on the mounting bracket.

17. The vehicle of claim 16, further comprising:
a side outer assembly connected with the side inner assembly; and
an adhesive pad attached to an outer surface of the mounting bracket and adhered to the side outer assembly.

18. The vehicle of claim 16, wherein the PSD drive unit includes mounting ribs extending in a radial manner;
wherein the mounting ribs include mounting sections disposed at a same distance from a mass center point of the PSD drive unit; and
further comprising rubber bushings at each of the mounting sections, respectively, such that the PSD drive unit is coupled to the mounting bracket via the rubber bushings.

19. The vehicle of claim 16, wherein the PSD drive unit includes a front cable and a rear cable connected to the quarter pillar inner member and the rear pillar inner member, respectively; and
wherein the PSD drive unit is mounted on the mounting bracket at a position such that lengths of the front cable and the rear cable are the same.

20. A vehicle comprising:
a power sliding door (PSD) drive unit configured to be coupled to a sliding side door and configured to move the sliding side door, wherein the PSD drive unit includes mounting ribs extending in a radial manner, and wherein the mounting ribs include mounting sections disposed at a same distance from a mass center point of the PSD drive unit;
a side structure comprising:
a side inner assembly including a quarter pillar inner member and a rear pillar inner member,
a quarter main member connected to the quarter pillar inner member and the rear pillar inner member of the side inner assembly along a longitudinal direction of the vehicle,
a wheel house connection member disposed below the quarter main member, wherein a mount space is defined between the quarter main member and the wheel house connection member, and
a mounting bracket disposed in the mount space, wherein the mounting bracket is connected to the quarter main member and the wheel house connection member, and wherein the PSD drive unit is mounted on the mounting bracket;
a side outer assembly connected with the side inner assembly;
an adhesive pad attached to an outer surface of the mounting bracket and adhered to the side outer assembly; and
rubber bushings at each of the mounting sections, respectively, such that the PSD drive unit is coupled to the mounting bracket via the rubber bushings,
wherein the PSD drive unit includes a front cable and a rear cable connected to the quarter pillar inner member and the rear pillar inner member, respectively, and
wherein the PSD drive unit is mounted on the mounting bracket at a position such that lengths of the front cable and the rear cable are the same.
